(19) United States
(12) Patent Application Publication
(10) Pub. No.: US 2025/0126563 A1
(43) Pub. Date: Apr. 17, 2025

(54) PAGING SIGNAL TRANSMISSION METHOD AND APPARATUS

(71) Applicant: ZTE Corporation, Shenzhen (CN)

(72) Inventors: Li NIU, Shenzhen (CN); Ting LU, Shenzhen (CN); Bo DAI, Shenzhen (CN); Yuan GAO, Shenzhen (CN)

(21) Appl. No.: 18/990,972

(22) Filed: Dec. 20, 2024

Related U.S. Application Data
(63) Continuation of application No. PCT/CN2023/071861, filed on Jan. 12, 2023.

(51) Int. Cl. H04W 52/02; H04W 24/10; H04W 68/02; H04W 76/28

(52) U.S. Cl. CPC H04W 52/0235; H04W 24/10; H04W 68/025; H04W 76/28

(57) ABSTRACT

This disclosure is directed to methods, systems, and devices related to wireless communication, and more specifically, to prolong battery life by using ultra-low power mechanism that can support low latency. A method of wireless communication, comprising receiving, by a wireless communication device, from a network device, a configuration of a low power wake-up signal (LP-WUS) in a serving cell; determining, by the wireless communication device, a reception of signals according to the configuration of LP-WUS; and wherein the signals contains a LP-WUS, a synchronization signal block (SSB) or a paging message.

### CROSS-REFERENCE TO RELATED APPLICATIONS

This application is a continuation of International Patent Application No. PCT/CN2023/071861, filed on Jan. 12, 2023, the disclosure of which is incorporated herein by reference in its entirety.

### TECHNICAL FIELD

This patent document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems

In one example aspect, a wireless communication method is disclosed. The method includes receiving, by a wireless communication device, from a network device, a configuration of a low power wake-up signal (LP-WUS) in a serving cell; determining, by the wireless communication device, a reception of signals according to the configuration of LP-WUS; and wherein the signals contains a LP-WUS, a synchronization signal block (SSB) or a paging message.

In another example aspect, another wireless communication method is disclosed. The method includes transmitting, to a wireless communication device, from a network device, a configuration of a low power wake-up signal (LP-WUS) in a serving cell; determining, by the wireless communication device, a reception of signals according to the configuration of LP-WUS; and wherein the signals contains a LP-WUS, a synchronization signal block (SSB) or a paging message.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the above-described method.

The above and other aspects and their implementations are described in greater detail in the drawings, the descriptions, and the claims.

### BRIEF DESCRIPTION OF THE DRAWINGS

FIG. 1 illustrates an example of the configuration of LP-WUS.

FIG. 2 illustrates another example of the configuration of LP-WUS.

FIG. 3 illustrates another example of the configuration of LP-WUS.

FIG. 4 illustrates an example of a network energy states according to the LP-WUS.

FIG. 5 is a flowchart illustrating an example method.

FIG. 6 is a flowchart illustrating an example method.

FIG. 7 is a block diagram example of a wireless communication system.

FIG. 8 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

The new radio (NR) technology of fifth generation (5G) mobile communication systems are designed and developed targeting for both mobile telephony and vertical use cases. Other than latency, reliability, and availability, UE energy efficiency is also critical to 5G. Currently, 5G devices may have to be recharged regularly, depending on individual's usage time. In general, 5G devices consume tens of milliwatts in Radio Resource Control (RRC) idle/inactive state and hundreds of milliwatts in RRC connected state. Designs to prolong battery life is beneficial for improving energy efficiency as well as for better user experience.

Energy efficiency is even more critical for user equipment (UE) without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least a few years. Wearables include smart watches, rings, eHealth related devices, and medical monitoring devices. With a typical battery capacity, it is challenging to sustain up to 1-2 weeks as required.

The power consumption depends on the configured length of wake-up periods, e.g., paging cycle. To meet the battery life requirements above, extended discontinuous reception (eDRX) cycle with large value is expected to be used, resulting in high latency, which is not suitable for such services with requirements of both long battery life and low latency. For example, in a fire detection and extinguishment use case, fire shutters may be closed and fire sprinklers may be turned on by the actuators within 1 to 2 seconds from the time the fire is detected by sensors; long eDRX cycle cannot meet the delay requirements. eDRX is apparently not suitable for latency-critical use cases. Thus, one goal of the present document is to propose an ultra-low power mechanism that can support low latency in Rel-18, e.g., lower than eDRX latency.

Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal to trigger the main radio (MR) and a separate receiver which has the ability to monitor wake-up signal with ultra-low power consumption. MR works for data transmission and reception, which can be turned off or set to deep sleep unless it is turned on.

Such techniques should primarily target low-power wake-up signal/wake-up receiver (WUS/WUR) for power-sensitive, small form-factor devices including IoT use cases (such as industrial sensors, controllers) and wearables. The present document provides solutions for the above discussed problems, and others.

### Embodiment 1 (Starting Condition)

The measurement of Synchronization Signal/PBCH (Physical Broadcast Channel) block (SSB) in serving cell requires UE to wake up and turn on an MR. In order to save UE power consumption, UE could perform a relaxed measurement in serving cell. The relaxed measurement in serving cell contains that UE measures LP-WUS instead of SSB in serving cell, or UE measures SSB in serving cell for every long periodicity.

In some embodiments, UE first measures SSB in serving cell. When UE satisfies the starting condition of relaxed measurement in serving cell, UE could perform the relaxed measurement in serving cell. When UE satisfies the stopping condition of relaxed measurement, UE measures SSB in serving cell.

If UE has to measure the SSB of a neighboring cell, UE has to turn on MR, and at the same time UE could measure SSB of a serving cell. Hence, if UE measures the neighboring cell, UE could measure the serving cell.

The possible starting conditions of the relaxed measurement in serving cell are as below:
If UE is not at cell edge, UE could perform a relaxed measurement in serving cell. Thus, a starting condition of the relaxed measurement is that the measurement result of SSB is higher than a threshold. When the measurement result of SSB is higher than the threshold, UE starts to perform the relaxed measurement in serving cell. gNB could broadcast the threshold for a relaxed serving cell measurement in SIB.
If UE is static or low mobility, UE could perform a relaxed measurement in serving cell. Thus, a starting condition of the relaxed measurement is that a variation of measurement result of SSB is lower than a threshold. When the variation of measurement result of SSB is lower than the threshold within a duration, UE starts to perform the relaxed measurement in serving cell. gNB could broadcast the threshold and the duration for relaxed serving cell measurement in SIB.
If UE does not start a neighboring cell measurement, UE could perform a relaxed measurement in serving cell. Thus, a starting condition of the relaxed measurement is that the measurement result of SSB is higher than an offset plus a threshold of the starting conditions of neighboring cell measurement. When the measurement result of SSB is higher than the threshold (e.g., X), UE would not start the neighboring cell measurement. When the measurement result of SSB is higher than the value of the offset plus the threshold of the starting conditions of neighboring cell measurement (e.g., an offset+X), UE starts the relaxed measurement in serving cell. gNB could broadcast the offset for relaxed serving cell measurement in system information blocks (SIB).
If UE does not start a relaxed neighboring cell measurement, UE could perform a relaxed measurement in serving cell. Thus, a starting condition of the relaxed measurement is that the measurement result of SSB is higher than an offset plus a threshold of the starting conditions of the relaxed neighboring cell measurement. When the measurement result of SSB is higher than the threshold (e.g., X), UE could start the relaxed neighboring cell measurement. When the measurement result of SSB is higher than the value of the offset plus the threshold of the starting conditions of the relaxed neighboring cell measurement (e.g., an offset+X), UE starts the relaxed measurement in serving cell. gNB could broadcast the offset for relaxed serving cell measurement in SIB.
If UE does not start a neighboring cell measurement, UE could perform a relaxed measurement in serving cell. Thus, a starting condition of relaxed measurement is that the measurement result of SSB is higher than an offset plus a threshold of the starting conditions of the neighboring cell measurement, and lower than the offset plus the threshold of the starting conditions of the relaxed neighboring cell measurement. When the measurement result of SSB is higher than the threshold (e.g., X), UE could start the relaxed neighboring cell measurement. When the measurement result of SSB is higher than the threshold (e.g., Y), UE would not start the neighboring cell measurement. When the measurement result of SSB is higher than the value of an offset1 plus the threshold of the starting conditions of the neighboring cell measurement (e.g., a, offset1+Y), and lower than an offset2 plus the threshold of the starting conditions of the relaxed neighboring cell measurement (e.g., an offset2+X), UE starts the relaxed measurement in serving cell. gNB could broadcast the offset1 and offset2 for relaxed serving cell measurement in SIB.

In various embodiments, the offset values discussed in this embodiment could be a positive, a negative or a zero value.

### Embodiment 2 (Stopping Conditions)

The stopping conditions of a relaxed measurement in serving cell are as below:
If UE is at a cell edge, UE could measure SSB. Thus, a stopping conditions of LP-WUS measurement is that a measurement result of LP-WUS is lower than a threshold. When the measurement result of LP-WUS is lower than the threshold, UE stops the relaxed measurement, and starts to measure SSB every DRX in serving cell. gNB could broadcast the threshold for LP-WUS measurement in SIB.
If UE is at a cell edge, UE could measure SSB. Thus, a stopping conditions of a relaxed measurement is that the relaxed measurement result of SSB is lower than a threshold. When the measurement result of SSB is lower than the threshold, UE stops the relaxed measurement, and starts to measure SSB every DRX in serving cell. gNB could broadcast the threshold for relaxed measurement in SIB.
If UE is not static or low mobility, UE may not be able to perform a relaxed measurement in serving cell. Thus, a stopping conditions of the relaxed measurement is that a variation of measurement result of SSB is higher than a threshold. When the variation of measurement result of SSB is higher than the threshold within a duration, UE stops to perform the relaxed measurement in serving cell. gNB could broadcast the threshold and the duration for relaxed serving cell measurement in SIB.
If UE is not static or low mobility, UE may not be able to perform a relaxed measurement in serving cell. Thus, a stopping conditions of the relaxed measurement is that a variation of measurement result of LP-WUS is higher than a threshold. When the variation of measurement result of SSB is higher than the threshold within a duration, UE stops to perform the relaxed measurement in serving cell. gNB could broadcast the threshold and the duration for relaxed serving cell measurement in SIB.
If the relaxed measurement only lasts a duration, a stopping condition of a relaxed measurement is that the measurement number or time reach a threshold. When the number of relaxed measurements reach the threshold, UE starts to measure SSB. gNB could broadcast the threshold for relaxed measurement in SIB. Alternatively, when UE starts the relaxed measurement, UE starts a timer. When the timer is running, UE performs the relaxed measurement. When the timer isn't running, UE measures SSB. When the timer expires, UE starts to measure SSB.
If UE starts a neighboring cell measurement, UE could stop to perform a relaxed measurement in serving cell. Thus, a stopping conditions of relaxed measurement is that the measurement result of SSB is less than an offset plus a threshold of the starting conditions of neighboring cell measurement. When the measurement result of SSB is higher than the threshold (e.g., X), UE couldn't start the neighboring cell measurement. When the measurement result of SSB is less than the value of the offset plus the threshold of the starting conditions of neighboring cell measurement (e.g., an offset+X), UE stops the relaxed measurement in serving cell. gNB could broadcast the offset for relaxed serving cell measurement in SIB.
If UE starts a relaxed neighboring cell measurement, UE could stop to perform a relaxed measurement in serving cell. Thus, a stopping conditions of relaxed measurement is that the measurement result of SSB is less than an offset plus a threshold of the starting conditions of the relaxed neighboring cell measurement. When the measurement result of SSB is higher than the threshold (e.g., X), UE could start the relaxed neighboring cell measurement. When the measurement result of SSB is less than the value of an offset plus the threshold of the starting conditions of the relaxed neighboring cell measurement (e.g., an offset+X), UE stops the relaxed measurement in serving cell. gNB could broadcast the offset for THE relaxed serving cell measurement in SIB.

### Embodiment 3 (Cell Selection)

It is helpful for UE to camp on a cell that supports LP-WUS in order to obtain a gain of power saving, thus, it is beneficial to prioritize the cell that supports LP-WUS.

The possible solutions are discussed below:
Introduce an offset into a cell reselection criterion, if a cell or frequency supports LP-WUS, an offset is added into R value of the cell or the frequency. The offset could be configured per cell or per frequency. During the cell reselection procedure, if the serving cell or frequency supports LP-WUS or SIB broadcasts the present an offset for the serving cell or frequency, cell-ranking criterion Rₛ for serving cell is added with Q_{offset_wus}, for example, Rₛ=Q_{meas,s}+Q_{hyst}−Qoffsetₜₑₘₚ+Q_{offset_wus}; if a neighboring cell or frequency supports LP-WUS, or SIB broadcasts the present offsets for thee neighboring cell or frequency, cell-ranking criterion Rₙ for neighboring cell is added with Q_{offset_wus}, for example, Rₙ=Q_{meas,n}−Qoffset−Qoffsetₜₑₘₚ+Q_{offset_wus}.
Prioritize a cell or the frequency that supports LP-WUS. During the cell reselection procedure, if the cell or frequency supports LP-WUS or SIB broadcasts with indication that the cell or frequency could be prioritized, UE could prioritize this cell or frequency at most.

### Embodiment 4 (Configuration)

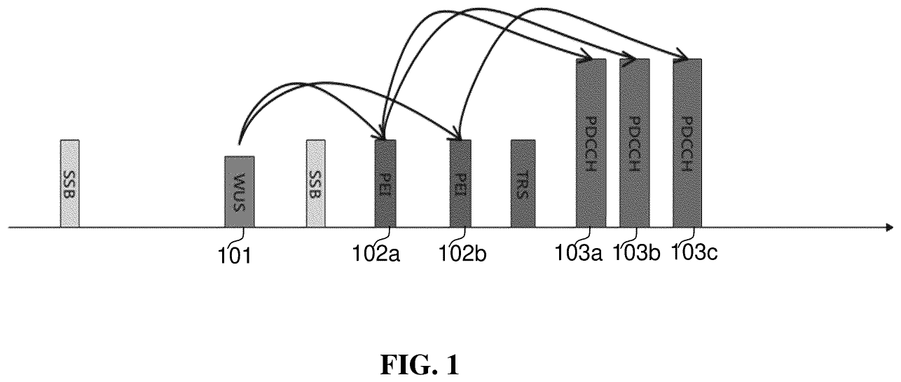

The LP-WUS (e.g., 101) could be used to indicate whether Paging Early Indication (PEI) (e.g., 102a-b) is transmitted in a DRX (e.g., 103a-c), as shown in FIG. 1.

If a paging needs to be transmitted, LP-WUSis transmitted to wake up UE to measure SSB, monitor PEI, monitor paging occasion (PO). If UE detects LP-WUS, UE monitors PEI. If PEI indicates a valid PO and a valid group, UE monitors the valid PO, and determines whether paging is transmitted in PO.

The configuration of LP-WUS, which could be determined by the following solutions:
A time domain of LP-WUS is determined by a start time of DRX. An offset could be configured to indicate an interval between LP-WUS (e.g., end or start of LP-WUS) and the start time of the DRX.
A time domain of LP-WUS is determined by a start time of a first PO in a DRX. Note that there are multiple POs in the DRX and the first PO is the earliest PO in DRX. An offset could be configured to indicate an interval between LP-WUS (e.g., end or start of LP-WUS) and the start time of the first PO in a DRX.
Atime domain of LP-WUS is determine by a start time of a first PEI (e.g., 102a) in a DRX. Note that there are multiple PEIs (e.g., 102a, 102b) in the DRX and the first PEI is the earliest PEI in DRX. An offset could be configured to indicate an interval between LP-WUS (e.g., end or start of LP-WUS) and the start time of the first PEI in a DRX.
LP-WUS periodicity is determined by a DRX cycle or times of DRX cycle.
A duration of LP-WUS could be configured to indicate a possible transmission rang of LP-WUS.

In the above solutions, the offset, periodicity, duration is broadcast in SIB or configured in RRC message.

### Embodiment 5 (Group LP-WUS)

A group LP-WUS could be used to indicate whether paging is transmitted for a group UEs in a DRX.

The group of UE could detect the same LP-WUS. If the UEs that belong to the same group are paged, the corresponding LP-WUS is transmitted. The group LP-WUS are divided based on either core network (CN) controlled grouping or UE ID based grouping. For CN controlled subgrouping, the group ID is indicated to UE via Non-Access-Stratum (NAS) procedure. For UE ID based subgrouping, UE could be divided into different groups based on UE ID (e.g., International Mobile Subscriber Identity (IMSI)). The group for LP-WUS could reuse the group for PEI.

If a paging needs to be transmitted, a group LP-WUS is transmitted to wake up a group of UEs to measure SSB, monitor PEI, and monitor PO. If UE detects LP-WUS, the group of UE would monitor PEI. If PEI indicates a valid PO, then UE monitors PO, and determines whether a paging is transmitted for it.

A group LP-WUS is transmitted in a sequence. For example, the i^{th} group LP-WUS is transmitted after the (i−1)^{th} group LP-WUS.

A time domain of a last group LP-WUS is determined by a, offset, as disclosed in embodiment 4. If gNB configures the offset and a duration for group LP-WUS, an interval between the end of i^{th} group LP-WUS and the start time of DRX or PO or PEI (see embodiment 4 for details) is (I−i) multiply by the duration and plus an offset, or i multiply by the duration and plus an offset, where I is the total member of group LP-WUS.

### Embodiment 6 (Group LP-WUS)

A group LP-WUS (e.g., 201) could be used to indicate whether paging is transmitted for a group of UEs that has a same PO, or multiple groups of UEs that have the multiple POs in a DRX.

If a paging needs to be transmitted in a DRX, a group LP-WUS (e.g., 201) is transmitted to wake up a group of UEs (e.g., 203a-c) that have a same PO (e.g., 202) to measure SSB, monitor PEI, monitor PO. If UE detects group LP-WUS, a group of UEs monitor PEI. If PEI indicates a valid PO and a valid group, UEs monitor PO, and determine whether paging is transmitted for it.

A group LP-WUS could be divided based on PO numbers in a DRX, and each group LP-WUS corresponds to a PO or multiple POs. If UE belongs to the same PO or multiple PO, UE could detect the same LP-WUS.

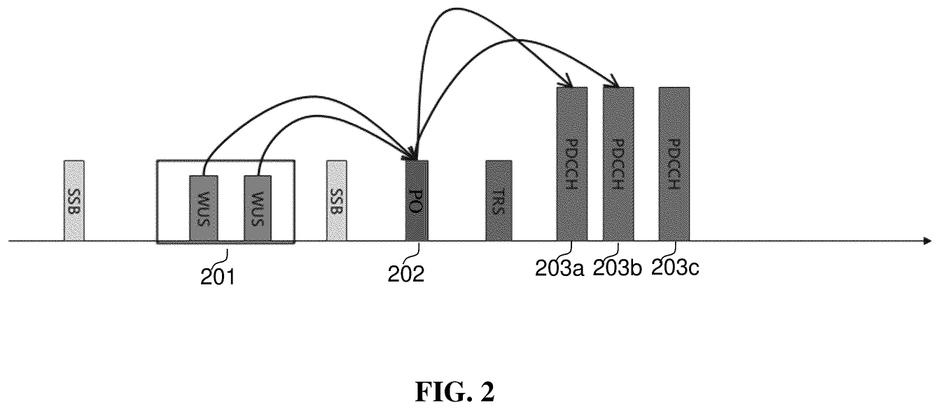

For example, there are X POs in a DRX, the total number of group LP-WUS is X, and each LP-WUS corresponds to each PO. If a LP-WUS is transmitted, the corresponding PO may be transmitted. In another example, there are X POs in a DRX, and the POs are divided into Y groups. In each group, there are X/Y POs. The total number of group LP-WUS is Y, and each LP-WUS corresponds to X/Y POs. When a LP-WUS is transmitted, the corresponding group of POs may be transmitted, as shown in FIG. 2.

The configuration of LP-WUS, in which the location in time domain is determined by PO.

An offset may be used to indicate an interval between an end of group LP-WUS and a start time of a first PO in a group. For example, P PO are a group, the start time of the first PO is the earliest PO in this a group of PO. The first PO associated with UE′ PO is provided by ((UE_IDmodN)·Nₛ+iₛ)mod P:
Index (is), indicating the index of the PO is determined by: is=floor (UE_ID/N) mod Ns,
T is determined by the shortest of the UE specific DRX value(s),
N: number of total paging frames in T, and
Ns: number of paging occasions for a PF.

### Embodiment 7 (Group LP-WUS)

A group LP-WUS (e.g., 301a-b) could be used to indicate whether paging is transmitted for a group of UE (e.g., 303a-b) that has the same PEI (e.g., 302a), or multiple groups of UE (e.g., 303a-b, 303c-d) that has the multiple PEI (e.g., 302a, 302b) in a DRX.

If a paging needs to be transmitted in a DRX, a group LP-WUS is transmitted to wake up a group of UEs that have the same PEI to measure SSB, monitor PEI, monitor PO. If UE detects group LP-WUS, a group of UEs monitor PEI. If PEI indicates a valid PO and a valid group, UE monitors PO, and determines whether paging is transmitted for it.

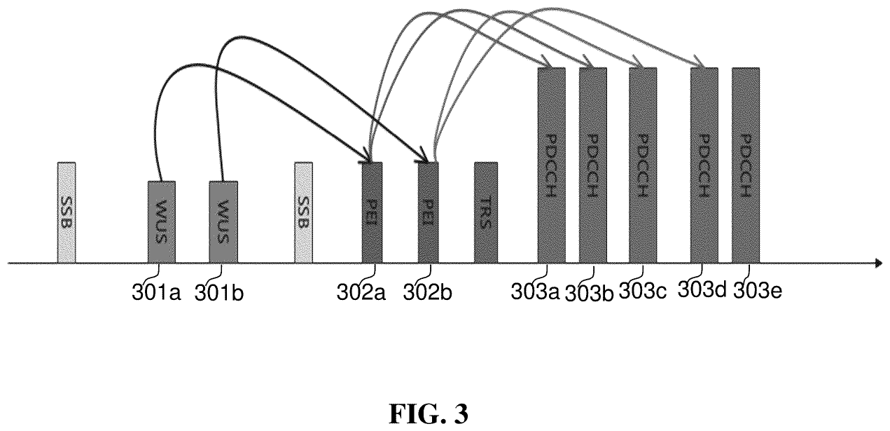

A group LP-WUS could be divided based on PEI numbers in a DRX, and each group LP-WUS corresponds to a PEI or multiple PEIs. For example, there are X PEIs in a DRX, the total number of group LP-WUS is X, and each LP-WUS corresponds to each PEI, if a LP-WUS is transmitted, the corresponding PEI may be transmitted. In another example, there are X PEIs in a DRX, and PEIs are divided into Y groups. In each group, there are X/Y PEIs. The total number of group LP-WUS is Y, and each LP-WUS corresponds to X/Y PEIs. If a LP-WUS is transmitted, the corresponding a group of PEI may be transmitted, as shown in FIG. 3.

The configuration of LP-WUS, in which the location in time domain is determined by PEI.

An offset may be used to indicate an interval between an end of WUS and a start time of a first PEI. For example, P PEI are a group, the start time of the first PEI is the earliest PEI in a group of PEI. The first PEI associated with UE′ PO is provided by ((UE_IDmodN)·Nₛ+iₛmodN_{PO}^{WUS}
N_{PO}^{WUS}=P*N_{PO}^{PEI}, N_{PO}^{PEI} is the PO number in a PEI,
Index (i_s), indicating the index of the PO is determined by: i_s=floor (UE_ID/N) mod Ns,
T is determined by the shortest of the UE specific DRX value(s),
N: number of total paging frames in T, and
Ns: number of paging occasions for a PF.

### Embodiment 8 (US Special LP-WUS)

gNB could allocate a UE special LP-WUS for a UE via RRC release message.

In idle/active mode, when UE receipts this LP-WUS, UE could consider that NW would like a connection with it, and UE trigger a Random Access Channel (RACH).

In order to make sure gNB could release the UE special LP-WUS timely, one of the following should occur:

A validation duration is configured to UE by gNB. When UE receives the configuration of LP-WUS, UE starts a timer (the length of the timer is the validation duration). When the timer expires, UE release the configuration of LP-WUS,

If UE moves out of a cell in idle/inactive mode; UE releases the configuration of LP-WUS,

If UE enters into connected mode; UE releases the configuration of LP-WUS.

When UE receives with UE special LP-WUS, one of the following actions of UE occurs:

In idle mode, PHY indicates RRC an indication. RRC deliver the upper layer an indication, and RRC initiate the RRC connection setup procedure; the indication could be that UE special LP-WUS is received, or a MT is triggered, or a connection with gNB need be setup and so on.

In inactive mode, PHY indicates RRC an indication, RRC initiate the RRC connection resumption procedure.

### Embodiment 9 (NES)

LP-WUS (e.g., 401) could be used to indicate a network energy state (NES) translation, such as from deep state to micro state, or from NES state to normal state in serving cell.

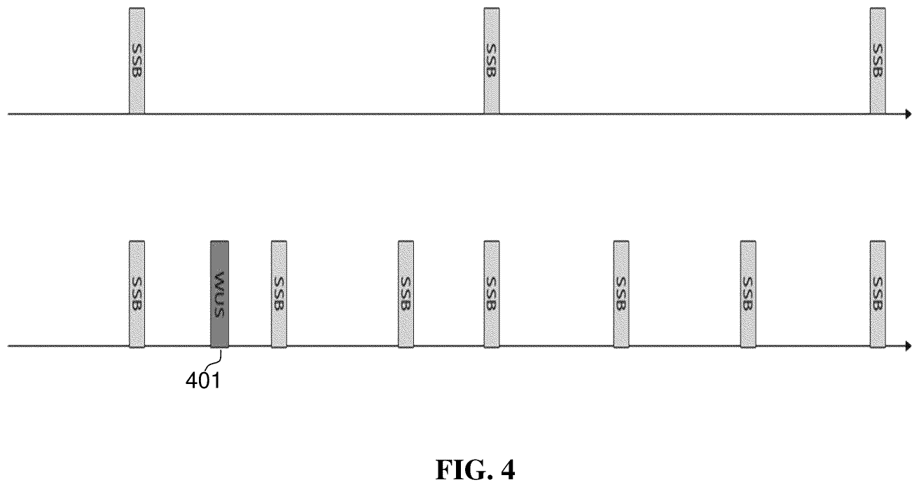

FIG. 4 shows an example of a network energy states according to the LP-WUS.

When UE detects LP-WUS (e.g., 401) for several times in serving cell, UE could consider that the serving cell wakes up, UE could apply a corresponding configuration. gNB could broadcast or configure multiple configurations, each configuration may correspond to the state of gNB, and under different state of gNB, the transmission or reception time is different. For example, one configuration #1 corresponds to the normal state of gNB, the transmission or reception time is dense. In another example, configuration #2 corresponds to the sleep state of gNB, the transmission or reception time is sparse. If UE detects LP-WUS for several times in serving cell, UE considers the normal state of gNB, UE could apply the configuration #1.

When UE detects LP-WUS and detect dense SSB in serving cell, UE could consider that the serving cell wakes up, UE could apply a corresponding configuration.

When UE didn't detect LP-WUS for several times in serving cell, UE could consider the deep state of serving cell, UE could apply a corresponding configuration. For example, if UE couldn't detect LP-WUS for several times in serving cell, UE considers the normal state of gNB, UE could apply the configuration #2.

LP-WUS could carry some information of NES state, including SSB periodicity information that indicates the SSB transmission periodicity, NES state (e.g., deep state, micro state, NES state, normal state and so on) changes flag that indicates the state of gNB has been changed, and so on.

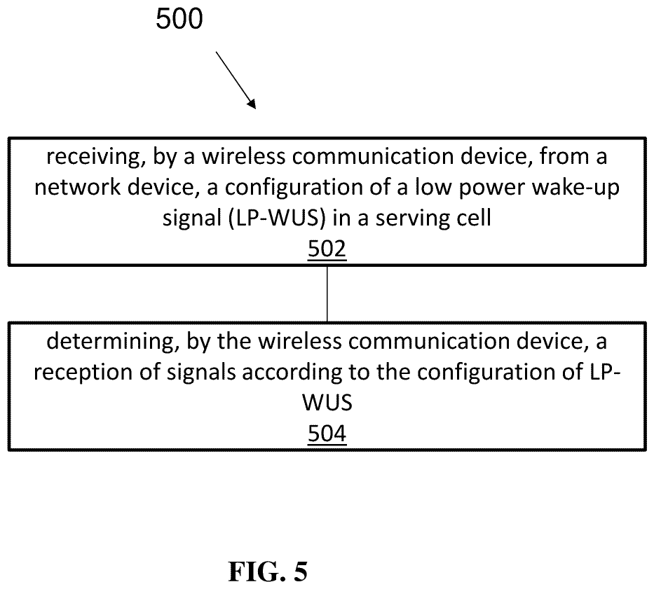

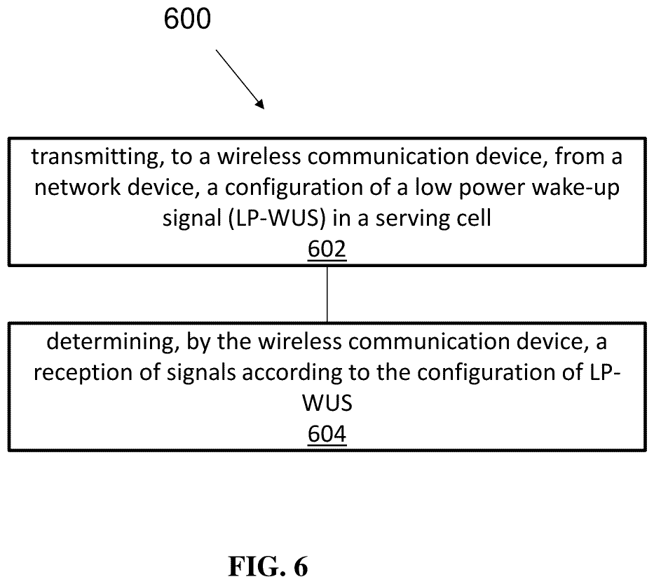

Accordingly, some preferred embodiments may use the following solutions.
1. A method of wireless communication, as disclosed in FIG. 5, including receiving, by a wireless communication device, from a network device, a configuration of a low power wake-up signal (LP-WUS) in a serving cell (502); determining, by the wireless communication device, a reception of signals according to the configuration of LP-WUS (504); and wherein the signals contains a LP-WUS, a synchronization signal block (SSB) or a paging message. Additional details and examples are discussed with respect to Embodiment 1.
2. The method of solution 1, wherein the wireless communication further comprising: determining a condition of the wireless communication device in the serving cell according to the configuration; performing a relaxed measurement in the serving cell; and wherein the relaxed measurement includes a LP-WUS measurement or a synchronization signal block (SSB) measurement.
3. The method of solution 2, wherein the condition of the wireless communication device is determined to be a starting condition to start the relaxed measurement in the serving cell; wherein the starting condition in the serving cell includes one of the following: a result of relaxed measurement of the SSB in the serving cell is higher than a threshold, a variation of the relaxed measurement results of the SSB in the serving cell is lower than a threshold, the relaxed measurement results of the SSB in the serving cell is higher than a threshold of a starting condition of a neighboring cell measurement plus an offset, the relaxed measurement results of the SSB in the serving cell is higher than a threshold of a starting condition of a relaxed neighboring cell measurement plus an offset, or the relaxed measurement results of the SSB in the serving cell is higher than a threshold of a starting condition of a neighboring cell measurement plus an offset but lower than a threshold of a starting condition of a relaxed neighboring cell measurement plus an offset.
4. The method of solution 2, wherein the condition of the wireless communication device is determined to be a stopping condition to stop the relaxed measurement in the serving cell; wherein the stopping condition in the serving cell includes one of the following: a result of LP-WUS measurement in the serving cell is lower than a threshold, a result of SSB measurement in the serving cell is lower than a threshold, a variation of the relaxed measurement results of the SSB in the serving cell is higher than a threshold, a variation of the relaxed measurement results of the LP-WUS in the serving cell is higher than a threshold, the relaxed measurement in the serving cell is within a time duration, a number of relaxed measurements in the serving cell reach a threshold, the relaxed measurement results of the SSB in the serving cell is lower than a threshold of a starting condition of a neighboring cell measurement plus an offset, the relaxed measurement results of the SSB in the serving cell is lower than a threshold of a stopping condition of a neighboring cell measurement plus an offset, the relaxed measurement results of the SSB in the serving cell is lower than a threshold of a starting condition of a relaxed neighboring cell measurement plus an offset, or the relaxed measurement results of the SSB in the serving cell is lower than a threshold of a stopping condition of a relaxed neighboring cell measurement plus an offset.
5. The method of solution 1, wherein the wireless communication further comprising: receiving, by the wireless communication device, from the network device, a configuration of a LP-WUS of a neighboring cell; and reselecting, by the wireless communication device, a cell during a cell reselection according to the configurations of the LP-WUS.
6. The method of solution 5, wherein the wireless communication device further performs one of the following: prioritizing the cell or a frequency that supports LP-WUS during cell reselection, or integrating an offset to the cell that supports LP-WUS during the cell reselection.
7. The method of solution 1, wherein the wireless communication device determines a time domain characteristic according to the LP-WUS configuration in serving cell.
8. The method of solution 7, wherein the time domain of the LP-WUS configuration is determined by one of the following: an offset for an interval between a start or end of the LP-WUS and a start time of a DRX cycle, an offset for an interval between a start or end of the LP-WUS and a start time of a first paging occasion (PO) in a DRX cycle, or an offset for an interval between a start or end of the LP-WUS and a start time of a first permanent equipment identifier (PEI) in a DRX cycle.
9. The method of solution 7, wherein a group of LP-WUS is used to indicate the paging message for a group of wireless communication devices in a DRX cycle; and wherein the group of LP-WUS is divided according to core network (CN) controlled grouping or wireless communication device identification (ID) based grouping.
10. The method of solution 7, wherein the time domain of a last group LP-WUS configuration is determined by an offset for an interval between a start or an end of the last group of LP-WUS and a start time of a DRX cycle.
11. The method of solution 7, wherein a group of LP-WUS can be divided according to PO numbers in a DRX cycle; and wherein each LP-WUS group correspond to one or more POs.
12. The method of solution 11, wherein the time domain of the group LP-WUS configuration is determined by an interval between a start or an end of a last group LP-WUS and a start time of a first PO in the DRX cycle.
13. The method of solution 7, wherein a group of LP-WUS can be divided according to PEI numbers in a DRX cycle; and wherein each LP-WUS group correspond to one or multiple PEIs.
14. The method of solution 11, wherein the time domain of the group LP-WUS configuration is determined by an interval between a start or an end of a last group LP-WUS and a start time of a first PEI in the DRX cycle.
15. The method of solution 1, the wireless communication device further comprising: receiving, by the wireless communication device, from the network device, a radio resource control (RRC) release message that indicates an allocation of a special low power wake-up signal (LP-WUS) for the wireless communication device; and configuring the wireless communication device to operate according to the special LP-WUS.
16. The method of solution 15, wherein the wireless communication device releases the special LP-WUS according to one of the following: a specified time duration, leaving the serving cell, or entering into connect mode.
17. The method of solution 15, wherein upon receiving the special LP-WUS, the wireless communication device performs one of the following actions: RRC transmits an upper layer indication and initiates a connection setup procedure when the wireless communication device is in idle mode or RRC initiates a resumption procedure when the wireless communication device is in inactive mode.
18. A method of wireless communication, as disclosed in FIG. 6, including transmitting, to a wireless communication device, from a network device, a configuration of a low power wake-up signal (LP-WUS) in a serving cell (602); determining, by the wireless communication device, a reception of signals according to the configuration of LP-WUS (604); and wherein the signals contains a LP-WUS, a synchronization signal block (SSB) or a paging message. Additional details and examples are discussed with respect to Embodiment 1.
19. The method of solution 18, wherein the wireless communication further comprising: determining a condition of the wireless communication device in the serving cell according to the configuration; performing a relaxed measurement in the serving cell; and wherein the relaxed measurement includes a LP-WUS measurement or a synchronization signal block (SSB) measurement.
20. The method of solution 19, wherein the condition of the wireless communication device is determined to be a starting condition to start the relaxed measurement in the serving cell; wherein the starting condition in the serving cell includes one of the following: a result of relaxed measurement of the SSB in the serving cell is higher than a threshold, a variation of the relaxed measurement results of the SSB in the serving cell is lower than a threshold, the relaxed measurement results of the SSB in the serving cell is higher than a threshold of a starting condition of a neighboring cell measurement plus an offset, the relaxed measurement results of the SSB in the serving cell is higher than a threshold of a starting condition of a relaxed neighboring cell measurement plus an offset, or the relaxed measurement results of the SSB in the serving cell is higher than a threshold of a starting condition of a neighboring cell measurement plus an offset but lower than a threshold of a starting condition of a relaxed neighboring cell measurement plus an offset.
21. The method of solution 19, wherein the condition of the wireless communication device is determined to be a stopping condition to stop the relaxed measurement in the serving cell; wherein the stopping condition in the serving cell includes one of the following: a result of LP-WUS measurement in the serving cell is lower than a threshold, a result of SSB measurement in the serving cell is lower than a threshold, a variation of the relaxed measurement results of the SSB in the serving cell is higher than a threshold, a variation of the relaxed measurement results of the LP-WUS in the serving cell is higher than a threshold, the relaxed measurement in the serving cell is within a time duration, a number of relaxed measurements in the serving cell reach a threshold, the relaxed measurement results of the SSB in the serving cell is lower than a threshold of a starting condition of a neighboring cell measurement plus an offset, the relaxed measurement results of the SSB in the serving cell is lower than a threshold of a stopping condition of a neighboring cell measurement plus an offset, the relaxed measurement results of the SSB in the serving cell is lower than a threshold of a starting condition of a relaxed neighboring cell measurement plus an offset, or the relaxed measurement results of the SSB in the serving cell is lower than a threshold of a stopping condition of a relaxed neighboring cell measurement plus an offset.
22. The method of solution 18, wherein the wireless communication further comprising: transmitting, to the wireless communication device, from the network device, a configuration of a LP-WUS of a neighboring cell; and reselecting, by the wireless communication device, a cell during a cell reselection according to the configurations of the LP-WUS.
23. The method of solution 22, wherein the wireless communication device further performs one of the following: prioritizing the cell or a frequency that supports LP-WUS during cell reselection, or integrating an offset to the cell that supports LP-WUS during the cell reselection.
24. The method of solution 18, wherein the wireless communication device a time domain characteristic according to the LP-WUS configuration in serving cell.
25. The method of solution 24, wherein the time domain of the LP-WUS configuration is determined by one of the following: an offset for an interval between a start or end of the LP-WUS and a start time of a DRX cycle, an offset for an interval between a start or end of the LP-WUS and a start time of a first paging occasion (PO) in a DRX cycle, or an offset for an interval between a start or end of the LP-WUS and a start time of a first permanent equipment identifier (PEI) in a DRX cycle.
26. The method of solution 24, wherein a group of LP-WUS is used to indicate the paging message for a group of wireless communication devices in a DRX cycle; and wherein the group of LP-WUS is divided according to core network (CN) controlled grouping or wireless communication device identification (ID) based grouping.
27. The method of solution 24, wherein the time domain of a last group LP-WUS configuration is determined by an offset for an interval between a start or an end of the last group of LP-WUS and a start time of a DRX cycle.
28. The method of solution 24, wherein a group of LP-WUS can be divided according to PO numbers in a DRX cycle; and wherein each LP-WUS group correspond to one or more POs.
29. The method of solution 28, wherein the time domain of the group LP-WUS configuration is determined by an interval between a start or an end of a last group LP-WUS and a start time of a first PO in the DRX cycle.
30. The method of solution 24, wherein a group of LP-WUS can be divided according to PEI numbers in a DRX cycle; and wherein each LP-WUS group correspond to one or multiple PEIs.
31. The method of solution 28, wherein the time domain of the group LP-WUS configuration is determined by an interval between a start or an end of a last group LP-WUS and a start time of a first PEI in the DRX cycle.
32. The method of solution 18, the wireless communication device further comprising: transmitting, to the wireless communication device, from the network device, a radio resource control (RRC) release message that indicates an allocation of a special low power wake-up signal (LP-WUS) for the wireless communication device; and configuring the wireless communication device to operate according to the special LP-WUS.
33. The method of solution 32, wherein the wireless communication device releases the special LP-WUS according to one of the following: a specified time duration, leaving the serving cell, or entering into connect mode.
34. The method of solution 32, wherein upon receiving the special LP-WUS, the wireless communication device performs one of the following actions: RRC transmits an upper layer indication and initiates a connection setup procedure when the wireless communication device is in idle mode or RRC initiates a resumption procedure when the wireless communication device is in inactive mode.
35. A communication apparatus comprising a processor configured to implement a method recited in any one or more of solutions 1 to 34.
36. A computer readable medium having code stored thereon, the code, when executed, causing a processor to implement a method recited in any one or more of solutions 1 to 34.

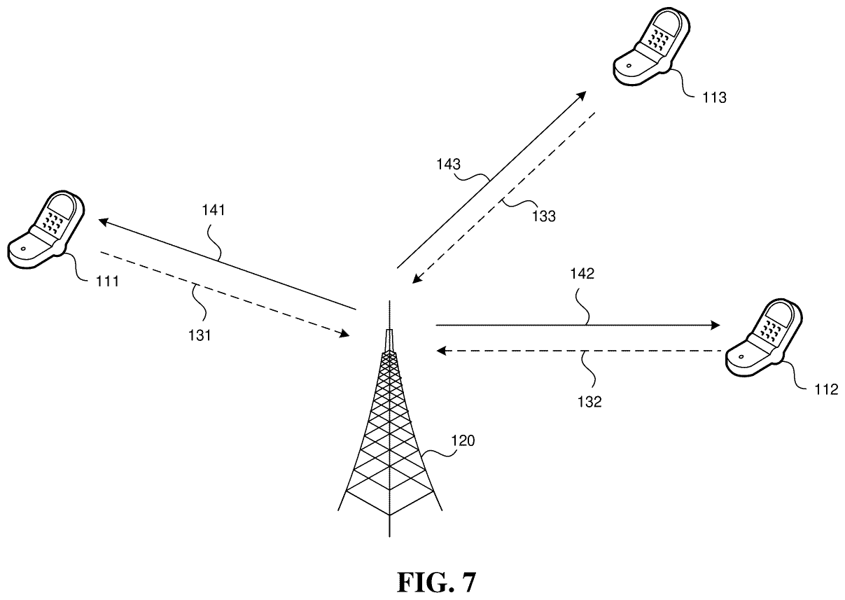

FIG. 7 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

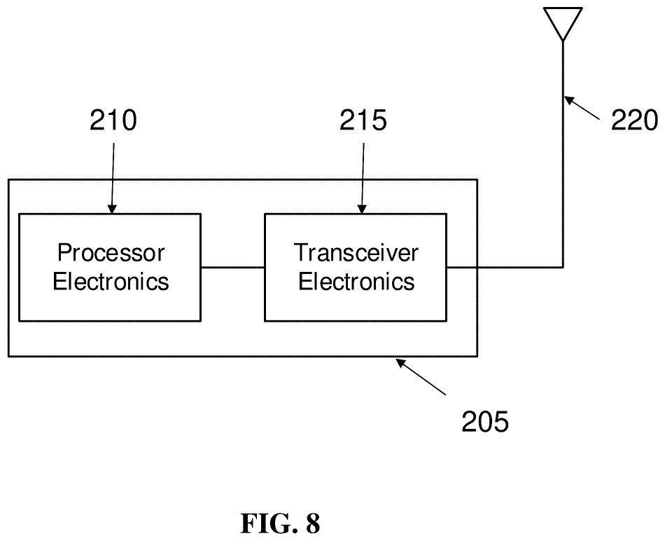

FIG. 8 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

1. A method of wireless communication, comprising:
receiving, by a wireless communication device, from a network device, a configuration of a low power wake-up signal (LP-WUS) in a serving cell; and
determining, by the wireless communication device, a reception of one or more signals according to the configuration of the LP-WUS,
wherein the one or more signals comprise the LP-WUS, a synchronization signal block (SSB), or a paging message.

2. The method of claim 1, further comprising:
determining a condition of the wireless communication device in the serving cell according to the configuration; and
performing a relaxed measurement in the serving cell,
wherein the relaxed measurement includes an LP-WUS measurement or an SSB measurement.

3. The method of claim 2, wherein the condition of the wireless communication device is determined to be a starting condition to start the relaxed measurement in the serving cell, and
wherein the starting condition in the serving cell comprises one of:
a result of the relaxed measurement of the SSB in the serving cell is higher than a first threshold,
a variation of the relaxed measurement results of the SSB in the serving cell is lower than a second threshold,
the result of the relaxed measurement of the SSB in the serving cell is higher than a threshold of a starting condition of a neighboring cell measurement plus a first offset,
the result of the relaxed measurement of the SSB in the serving cell is higher than a threshold of a starting condition of a relaxed neighboring cell measurement plus a second offset, or
the result of the relaxed measurement of the SSB in the serving cell is higher than the threshold of the starting condition of the neighboring cell measurement plus the first offset but lower than the threshold of the starting condition of the relaxed neighboring cell measurement plus the second offset.

4. The method of claim 2, wherein the condition of the wireless communication device is determined to be a stopping condition to stop the relaxed measurement in the serving cell, and wherein the stopping condition in the serving cell comprises one of:
a result of the LP-WUS measurement in the serving cell is lower than a first threshold,
a result of the SSB measurement in the serving cell is lower than a second threshold,
a variation of relaxed measurement results of the SSB in the serving cell is higher than a third threshold,
a variation of relaxed measurement results of the LP-WUS in the serving cell is higher than a fourth threshold,
the relaxed measurement in the serving cell is within a time duration,
a number of relaxed measurements in the serving cell reach a fifth threshold,
the relaxed measurement results of the SSB in the serving cell is lower than a threshold of a starting condition of a neighboring cell measurement plus a first offset,
the relaxed measurement results of the SSB in the serving cell is lower than a threshold of a stopping condition of the neighboring cell measurement plus a second offset,
the relaxed measurement results of the SSB in the serving cell is lower than a threshold of a starting condition of a relaxed neighboring cell measurement plus a third offset, or
the relaxed measurement results of the SSB in the serving cell is lower than a threshold of a stopping condition of the relaxed neighboring cell measurement plus a fourth offset.

5. The method of claim 1, further comprising:
receiving, by the wireless communication device, from the network device, a configuration of an LP-WUS of a neighboring cell; and
reselecting, by the wireless communication device, a cell during a cell reselection according to the configurations of the LP-WUS of the neighboring cell.

6. The method of claim 5, further comprising:
prioritizing the cell or a frequency that supports the LP-WUS during the cell reselection, or
integrating an offset to the cell that supports the LP-WUS of the neighboring cell during the cell reselection.

7. The method of claim 1, wherein the wireless communication device determines a time domain characteristic according to the configuration of the LP-WUS in the serving cell.

8. The method of claim 7, wherein the time domain characteristic of the LP-WUS configuration is determined by one of:
an offset for an interval between a start or end of the LP-WUS and a start time of a DRX cycle,
the offset for the interval between the start or end of the LP-WUS and a start time of a first paging occasion (PO) in the DRX cycle, or
the offset for the interval between the start or end of the LP-WUS and a start time of a first permanent equipment identifier (PEI) in the DRX cycle.

9. The method of claim 1, further comprising:
receiving, by the wireless communication device, from the network device, a radio resource control (RRC) release message that indicates an allocation of a special LP-WUS for the wireless communication device; and
configuring the wireless communication device to operate according to the special LP-WUS.

10. The method of claim 9, wherein the wireless communication device releases the special LP-WUS according to one of: a specified time duration, leaving the serving cell, or entering into a connect mode, and wherein upon receiving the special LP-WUS, the wireless communication device performs one of following actions:
the RRC transmits an upper layer indication and initiates a connection setup procedure when the wireless communication device is in an idle mode; or
the RRC initiates a resumption procedure when the wireless communication device is in an inactive mode.

11. A method of wireless communication, comprising:
transmitting, to a wireless communication device, from a network device, a configuration of a low power wake-up signal (LP-WUS) in a serving cell, wherein a reception of one or more signals is determined according to the configuration of the LP-WUS in the serving cell, and
wherein the one or more signals comprise the LP-WUS, a synchronization signal block (SSB), or a paging message.

12. The method of claim 11, wherein a condition of the wireless communication device is determined to be a starting condition to start a relaxed measurement in the serving cell according to the configuration; and
wherein the starting condition in the serving cell comprises one of:
a result of the relaxed measurement of the SSB in the serving cell is higher than a first threshold,
a variation of the relaxed measurement results of the SSB in the serving cell is lower than a second threshold,
the result of the relaxed measurement of the SSB in the serving cell is higher than a threshold of a starting condition of a neighboring cell measurement plus a first offset,
the result of the relaxed measurement of the SSB in the serving cell is higher than a threshold of a starting condition of a relaxed neighboring cell measurement plus a second offset, or
the result of the relaxed measurement of the SSB in the serving cell is higher than the threshold of the starting condition of the neighboring cell measurement plus the first offset but lower than the threshold of the starting condition of the relaxed neighboring cell measurement plus the second offset.

13. The method of claim 11, wherein a condition of the wireless communication device is determined to be a stopping condition to stop a relaxed measurement in the serving cell according to the configuration, and
wherein the stopping condition in the serving cell comprises one of:
a result of the LP-WUS measurement in the serving cell is lower than a first threshold,
a result of the SSB measurement in the serving cell is lower than a second threshold,
a variation of relaxed measurement results of the SSB in the serving cell is higher than a third threshold,
a variation of relaxed measurement results of the LP-WUS in the serving cell is higher than a fourth threshold,
the relaxed measurement in the serving cell is within a time duration,
a number of relaxed measurements in the serving cell reach a fifth threshold,
the relaxed measurement results of the SSB in the serving cell is lower than a threshold of a starting condition of a neighboring cell measurement plus a first offset,
the relaxed measurement results of the SSB in the serving cell is lower than a threshold of a stopping condition of the neighboring cell measurement plus a second offset,
the relaxed measurement results of the SSB in the serving cell is lower than a threshold of a starting condition of a relaxed neighboring cell measurement plus a third offset, or
the relaxed measurement results of the SSB in the serving cell is lower than a threshold of a stopping condition of the relaxed neighboring cell measurement plus a fourth offset.

14. The method of claim 11, further comprising:
transmitting, to the wireless communication device, from the network device, a configuration of an LP-WUS of a neighboring cell, whereina cell is reselected during a cell reselection according to the configurations of the LP-WUS of the neighboring cell.

15. The method of claim 11, further comprising:
transmitting, to the wireless communication device, from the network device, a radio resource control (RRC) release message that indicates an allocation of a special LP-WUS for the wireless communication device.

16. A wireless communication device comprising a processor configured to implement a method comprising:
receiving from a network device a configuration of a low power wake-up signal (LP-WUS) in a serving cell; and
determining a reception of one or more signals according to the configuration of the LP-WUS,
wherein the one or more signals comprise the LP-WUS, a synchronization signal block (SSB), or a paging message.

17. The wireless communication device of claim 16, the processor configured to implement the method further comprising:
determining a condition of the wireless communication device in the serving cell according to the configuration; and
performing a relaxed measurement in the serving cell,
wherein the relaxed measurement includes an LP-WUS measurement or an SSB measurement.

18. The wireless communication device of claim 17, wherein the condition of the wireless communication device is determined to be a starting condition to start the relaxed measurement in the serving cell, and
wherein the starting condition in the serving cell comprises one of:
a result of the relaxed measurement of the SSB in the serving cell is higher than a first threshold,
a variation of the relaxed measurement results of the SSB in the serving cell is lower than a second threshold,
the result of the relaxed measurement of the SSB in the serving cell is higher than a threshold of a starting condition of a neighboring cell measurement plus a first offset,
the result of the relaxed measurement of the SSB in the serving cell is higher than a threshold of a starting condition of a relaxed neighboring cell measurement plus a second offset, or
the result of the relaxed measurement of the SSB in the serving cell is higher than the threshold of the starting condition of the neighboring cell measurement plus the first offset but lower than the threshold of the starting condition of the relaxed neighboring cell measurement plus the second offset.

19. The wireless communication device of claim 17, wherein the condition of the wireless communication device is determined to be a stopping condition to stop the relaxed measurement in the serving cell, and wherein the stopping condition in the serving cell comprises one of:
a result of the LP-WUS measurement in the serving cell is lower than a first threshold,
a result of the SSB measurement in the serving cell is lower than a second threshold,
a variation of relaxed measurement results of the SSB in the serving cell is higher than a third threshold,
a variation of relaxed measurement results of the LP-WUS in the serving cell is higher than a fourth threshold,
the relaxed measurement in the serving cell is within a time duration,
a number of relaxed measurements in the serving cell reach a fifth threshold,
the relaxed measurement results of the SSB in the serving cell is lower than a threshold of a starting condition of a neighboring cell measurement plus a first offset,
the relaxed measurement results of the SSB in the serving cell is lower than a threshold of a stopping condition of the neighboring cell measurement plus a second offset,
the relaxed measurement results of the SSB in the serving cell is lower than a threshold of a starting condition of a relaxed neighboring cell measurement plus a third offset, or
the relaxed measurement results of the SSB in the serving cell is lower than a threshold of a stopping condition of the relaxed neighboring cell measurement plus a fourth offset.

20. The wireless communication device of claim 16, the processor configured to implement the method further comprising:
receiving from the network device, a configuration of an LP-WUS of a neighboring cell; and
reselecting a cell during a cell reselection according to the configurations of the LP-WUS of the neighboring cell.
